(19) United States
(12) Patent Application Publication
(10) Pub. No.: US 2017/0061431 A1
(43) Pub. Date: Mar. 2, 2017

(54) Systems and Methods of Securing MO/TO Processing

(71) Applicant: MASTERCARD INTERNATIONAL INCORPORATED, Purchase, NY (US)

(72) Inventors: Sebastien Christopher Slatter, London (GB); Michael John Cowen, London (GB)

(21) Appl. No.: 15/248,365

(22) Filed: Aug. 26, 2016

(30) Foreign Application Priority Data
Aug. 28, 2015 (EP) 15183059.3

(51) Int. Cl. G06Q 20/40; G06Q 20/38

(52) U.S. Cl. CPC G06Q 20/401; G06Q 20/382

(57) ABSTRACT

In one aspect, a method of securing a Mail Order/Telephone Order (MO/TO) transaction is provided. The method is performed by a MO/TO account holder-facing application running on a processor of an account holder computing device, and includes receiving a MO/TO token request from an account holder; and responsive thereto, obtaining data corresponding to a token for use in a MO/TO transaction request to be provided to a merchant having access to a merchant-facing application corresponding to said account holder-facing application. In another aspect, a method of processing a MO/TO transaction is provided. The method is performed by a MO/TO merchant-facing application running on a processor of a merchant computing device, and includes receiving a MO/TO transaction request, comprising data corresponding to a token, from a merchant; and responsive thereto, initiating obtaining payment credentials using said token.

### FIELD

The present disclosure generally relates to systems and methods of securing and processing mail order/telephone order (MO/TO) transactions, computer-readable media for storing instructions which, when executed, cause a processor to implement such methods, and computer systems in which such methods are implemented.

### BACKGROUND

This section provides background information related to the present disclosure which is not necessarily prior art.

Card not present (CNP) transactions are payment card transactions made without a payment (e.g. debit or credit) card being physically present at a merchant point of sale (POS). CNP transactions include mail order transactions and telephone order transactions, collectively known as MO/TO transactions.

To make a MO/TO transaction, an account holder must provide a merchant with certain payment credentials, usually details present on their payment card such as the card number, the name of the account holder, the card expiry date and a security code (e.g. card verification value, CVV, or card security code, CSC). Therefore, all that is required for a criminal to make fraudulent MO/TO transactions is access to these details, whether by stealing the physical card, or by gaining sight of it for long enough to make images of it or copy down the details on it.

Due to the ease with which fraudulent MO/TO transactions can be made, the liability for restitution of them is reversed. That is, while for a card present transaction at a POS, the card issuer (i.e. the account holder's bank), must make restitution if the transaction is later found to be fraudulent, for CNP transactions the acquirer (i.e. the merchant's bank) bears responsibility for restitution. Some banks charge higher interchange fees to merchants who routinely handle CNP transactions due to the greater risk involved.

In addition, merchants who take MO/TO transactions must ensure compliance with strict payment card industry data security standards (PCI DSS). Maintaining a PCI compliant call centre, for instance, is costly and burdensome. A secure room must be provided into which staff are not permitted to take writing materials or mobile telephones. Compliance must also be closely monitored. If calls are recorded then the recording must be paused while payment credentials are communicated. Some merchants even implement advanced telephony systems which pass calls to an automated service at the point where credentials are required to allow customers to enter credentials via their telephone's keypad or by speaking to a speech recognition system rather than providing credentials to a customer service agent.

What is needed are improved methods of securing and processing MO/TO transactions that reduce the burden on merchants.

SUMMARY

This section provides a general summary of the disclosure, and is not a comprehensive disclosure of its full scope or all of its features. Aspects and embodiments of the disclosure are also set out in the accompanying claims.

According to a first aspect there is provided a method of processing a Mail Order/Telephone Order (MO/TO) transaction, said method being performed by a MO/TO merchant-facing application running on a processor of a merchant computing device and comprising: receiving a MO/TO transaction request, comprising data corresponding to a token, from a merchant; and responsive thereto, initiating obtaining payment credentials using said data.

The method could further comprise initiating validation of said credentials to authorise and complete said transaction. The method could further comprise, subsequent to said authorisation, receiving a transaction approval. The method could further comprise, responsive thereto, providing said merchant with a transaction confirmation.

Said obtaining could comprise matching the data corresponding to a token to data corresponding to the credentials. The data corresponding to the credentials could be stored by said payment application or an entity in communication with it.

Said matching could comprise searching for the data corresponding to the token, or a code derived therefrom, according to a predetermined algorithm, in a look-up table comprising pairs of linked token data and credential data.

Said obtaining could comprise operating on the data corresponding to the token according to a predetermined decoding algorithm to output data corresponding to the credentials.

Said transaction request could further comprise a timestamp. Both the data corresponding to the token and said timestamp could be input to said decoding algorithm.

Said obtaining could comprise checking that the token is not present on a list of previously used tokens.

According to a second aspect there is provided a computer-readable medium storing computer-executable instructions that, when performed by a processor, cause said processor to perform the method of the first aspect.

According to a third aspect there is provided a method of securing a Mail Order/Telephone Order (MO/TO) transaction, said method being performed by a MO/TO account holder-facing application running on a processor of an account holder computing device and comprising: receiving a MO/TO token request from an account holder; and responsive thereto, obtaining data corresponding to a token for use in a MO/TO transaction request to be provided to a merchant having access to a merchant-facing application corresponding to said account holder-facing application, said merchant-facing application being configured to initiate obtaining payment credentials using said data corresponding to the token.

The method could further comprise, prior to said obtaining, verifying said account holder's identity.

Said obtaining could comprise operating on data corresponding to a stored account identifier for an account held by said account holder according to a predetermined algorithm.

Said operating could further comprise inputting data corresponding to a current time value to said algorithm.

Said merchant-facing application could be configured to subsequently perform the method of the first aspect.

According to a fourth aspect there is provided a computer-readable medium storing computer-executable instructions that, when performed by a processor, cause said processor to perform the method of the third aspect.

According to a fifth aspect there is provided a computer system comprising a processor and a memory, said memory storing computer-executable instructions that, when performed by said processor, cause said processor to perform the method of either of the first or third aspects.

Further areas of applicability will become apparent from the description provided herein. The description and specific examples and embodiments in this summary are intended for purposes of illustration only and are not intended to limit the scope of the present disclosure. In addition, the above and other features will be better understood with reference to the followings Figures which are provided to assist in an understanding of the present teaching.

### DRAWINGS

The drawings described herein are for illustrative purposes only of selected embodiments and not all possible implementations, and are not intended to limit the scope of the present disclosure.

Implementations will now be described in detail, by way of example only, with reference to the accompanying drawings, in which:

FIG. 1 illustrates an example MO/TO system;

FIG. 2 illustrates an example MO/TO transaction process flow;

FIG. 3A illustrates a method of processing a MO/TO transaction performed by a MO/TO merchant-facing application;

FIG. 3B illustrates a method of securing a MO/TO transaction performed by a MO/TO account holder-facing application; and

FIG. 4 illustrates an example computing system which could be used to perform either or both of the methods of FIGS. 3A and 3B.

Corresponding reference numerals generally indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

The following description is presented to enable any person skilled in the art to make and use the system, and is provided in the context of a particular application. Various modifications to the disclosed embodiments will be readily apparent to those skilled in the art.

It is proposed to replace the transfer of payment credentials from an account holder to a merchant in a MO/TO transaction procedure with the transfer of a token. The token is input to a MO/TO merchant-facing application which initiates obtaining payment credentials linked to the token.

According to such a procedure, the payment credentials need never be made available to the customer service agent. The data security restrictions required of the merchant are thus significantly reduced. The liability for restitution of fraudulent payments could even perhaps be shifted on to the issuer as in a card present transaction.

The token used need not be as long as conventional card payment credentials (16 digit card number, 4 digit expiry date, 3 digit CVV or CSC and the account holder's name). The likelihood of the account holder making errors when providing information necessary to complete the transaction, and the time taken to provide the information, can therefore be reduced.

The token could be a single use token generated by a MO/TO account holder-facing application in response to a request made by the account holder each time they wish to make a MO/TO transaction. Such an account-holder facing application could comprise further functionality. For example, it could be an electronic wallet application such as MasterPass®, Apple Pay™ or Samsung Pay®.

The account holder-facing application could generate a unique token according to a predetermined algorithm with inputs of one or more of the payment credentials (or other details of the account or account holder, e.g. an account nickname specified by the account holder) and a timestamp, e.g. of the time the account holder-facing application receives a token request. The token could, for example, be generated by performing a mathematical operation on the payment credentials and the time, to encrypt the payment credentials, and appending or otherwise incorporating the timestamp to act as a decoding key. Alternatively, the algorithm used to encrypt the payment credentials could be time-varying, e.g. changing periodically, and the timestamp could be appended to or otherwise incorporated into the token to inform the merchant-facing application which version of the algorithm to use. In either case, the token could then be further encrypted. The payment credentials would thus be encoded in such a way that only a processor running a corresponding secret decoding algorithm could extract them from the token. In this example, the merchant-facing application would run such a decoding algorithm.

Alternatively, the token need not comprise the payment credentials at all, whether in an encrypted or otherwise modified form. Instead, the merchant-facing application could have read-access to a database/correspondence table in which each set of payment credentials is stored in association with one or more corresponding tokens. Such read-access could be direct access or access provided by an application programming interface (API). Using an API can improve the scalability and security of the system. The merchant-facing application (or the API) could then look up each received token in the table to obtain the corresponding payment credentials and process the transaction request using them. Such a table could be stored on a server in communication with one or both of the merchant-facing and account holder-facing applications. If an API is used, the server and API could be controlled by the same entity.

Such an arrangement could be adapted to incorporate single use tokens if the token stored in the table can be over-written once per transaction request. If the merchant-facing application (or API) has write-access to the table, over-writing or deletion of a token in the table could be performed by the merchant-facing application following matching of a received token to the token in the table. Alternatively or additionally, over-writing could be performed by the account holder-facing application, if it has write-access to the table (or writing if a token has not been generated for an account previously or the previous token has been deleted). This could be done in response to receipt of a request to generate a new token. Deleting/over-writing ensures only one record's worth of memory space is used for each account. However, rather than over-writing or deleting used tokens, it may be preferable, in some circumstances, to instead include an additional field indicating whether or not the token has been used (to be updated by the merchant-facing application). For example, if a record of the token and its use is required to be kept e.g. for legal compliance purposes. Alternatively, a list of used tokens could be maintained to which the merchant-facing application refers on receipt of a token. If the received token is found on the list, the transaction is declined.

Additional security could be provided by the account holder-facing application encrypting the token before sending it to the merchant-facing application, which then decrypts it.

Verification of the account holder's identity could also be completed by means of a log-on process for the account holder-facing application which must be successfully completed in order for a token to be generated.

The account holder-facing application could be a digital wallet application e.g. storing details of various debit and/or credit and/or prepaid and/or currency and/or loyalty accounts. The account holder may be required to select an account from a plurality of accounts stored in the digital wallet either before requesting a token or as part of the token request process.

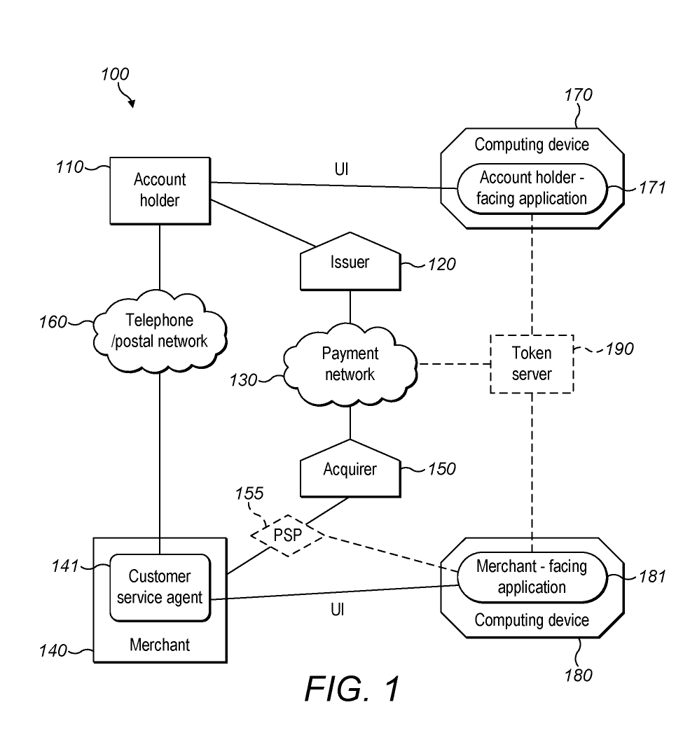

FIG. 1 illustrates a system 100 in which the methods described herein can be used. An account holder 110 holds an account with issuer bank 120. Issuer 120 is part of a payment association which uses payment network 130. Merchant 140 has an account with acquirer bank 150. Acquirer 150 is also part of the payment association that uses payment network 130. Merchant 140′s relationship with acquirer 150 could optionally be through a payment service provider (PSP) 155. Account holder 110 communicates with a customer service agent 151 of merchant 140 via postal or telephone network 160 to make transactions which are processed via acquirer 150, payment network 130 and issuer 120.

Account holder 110 can communicate with an account holder-facing application 171 through a user interface (UI) of a computing device, such as a smartphone, tablet, laptop or desktop personal computer (PC) 170. Similarly, merchant 140 can communicate with a merchant-facing application 181 through a UI of a computing device 180.

Optionally, a token server 190 may be capable of communicating with one or more of account holder-facing application 171, merchant-facing application 181 and payment network 130. Such communication can, for example, be via the internet or other wired (e.g. telephone) or wireless (e.g. cellular) network.

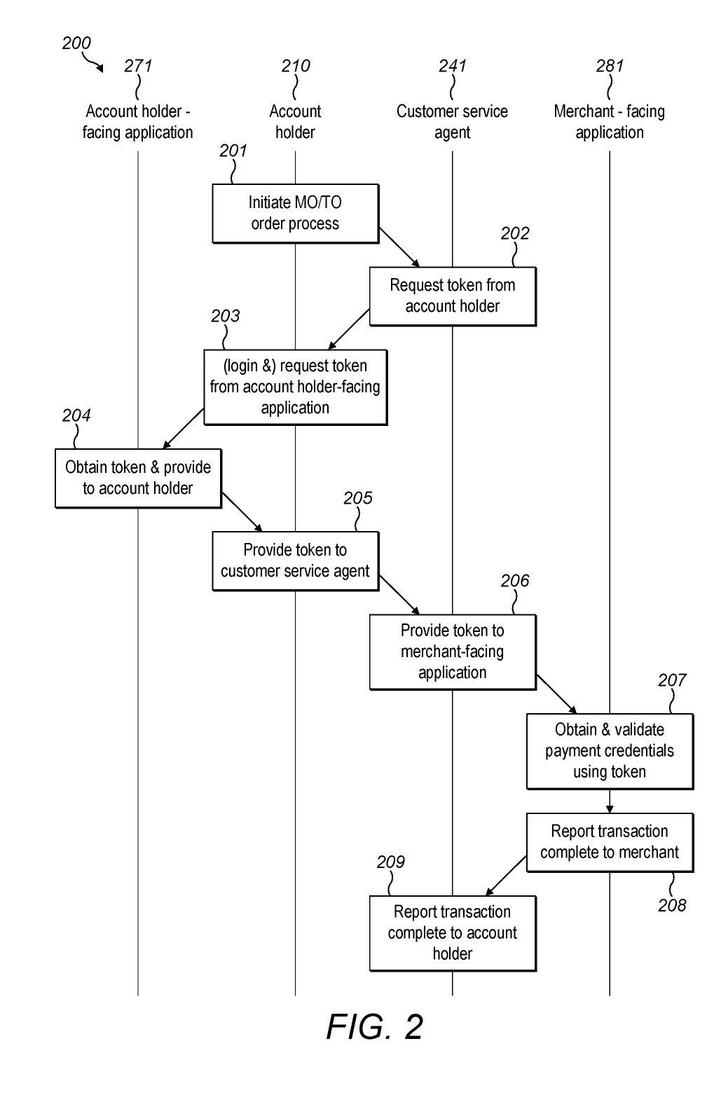

FIG. 2 illustrates an example tokenised MO/TO transaction procedure 200. At 201, account holder 210 initiates the order process, e.g. by telephoning a merchant call centre. At 202, merchant customer service agent 241 (e.g. a call centre operative) requests a token from the account holder.

At 203, the account holder requests a token from account holder-facing application 271 through a UI of a user device on which the account holder-facing application is running (e.g. a touchscreen, keypad, mouse or microphone with voice recognition system of a smartphone, tablet, laptop or desktop PC). This step may optionally also comprise the account holder logging into the account holder-facing application to verify their identity.

At 204 the account holder-facing application obtains a token and provides it to the account holder by means of a user interface of the user device (which may be the same as the input user interface, e.g. a touchscreen, or different, e.g. a speaker). There are several different ways in which the account holder-facing application could obtain the token. As one example, the token could be stored in a memory of the computing device accessible to the account holder-facing application, so that the token can be obtained by retrieving it from that memory. Alternatively, the account holder-facing application could generate the token, e.g. according to a predetermined algorithm. As another alternative, it could request a token from a token server, which could similarly either retrieve the token from memory or generate it on request, then return the token to the account holder-facing application.

At 205 the account holder provides the token to the customer service agent, e.g. by reading it over the telephone or typing it using their telephone keypad. At 206, the customer service agent passes the token to merchant-facing application 281, e.g. by typing it in as the account holder reads it to them.

At 207 the merchant-facing application uses the token to obtain and validate payment credentials, e.g. by searching a look-up table stored on a token server for the token (or having an API do this) and passing payment credentials stored with the token in the table to a payment network as part of a transaction request (again, the API could handle this part). For example, if the system comprises a token server and a PSP, step 207 could proceed as follows. The merchant-facing application could pass the token to the token server for verification. The token server could, in response to verifying the token, deliver payment credentials to the merchant-facing application. (NB: the payment credentials would not be accessible to the customer service agent.) The merchant-facing application could then transmit a transaction request comprising the payment credentials and details of the transaction to the PSP in the same manner a merchant normally would in the absence of the merchant-facing application and tokenisation. The PSP could then forward this to the issuer via the acquirer and payment network as normal. If the issuer approves the transaction then the approval is passed back to the merchant-facing application via the payment network, acquirer and PSP.

At 208, the merchant-facing application reports completion of the transaction to the customer service agent, e.g. through an on-screen message, and at 209 the customer service agent confirms this to the account holder.

If a receipt for the transaction is to be issued, this can be done manually by the customer service agent via post or email. Alternatively, the merchant-facing application could automatically initiate transmission of a receipt. This could be done via email if the account holder's email address has been obtained, or if the merchant-facing and account holder-facing applications can communicate (e.g. via a token server), the merchant-facing application could pass receipt data to the account holder-facing application, which could then present an electronic receipt to the account holder.

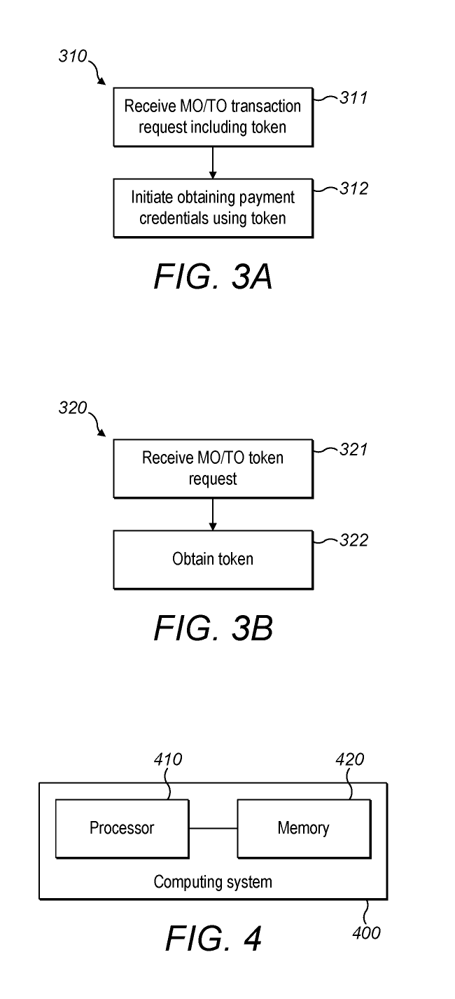

FIG. 3A illustrates a method 310 of processing a MO/TO transaction performed by a MO/TO merchant-facing application. At 311 the merchant-facing application receives a MO/TO transaction request, comprising a token, from a merchant. Responsive thereto, at 312, the merchant-facing application initiates obtaining payment credentials using said token.

FIG. 3B illustrates a method 320 of securing a MO/TO transaction performed by a MO/TO account holder-facing application. At 321 the account holder-facing application receives a MO/TO token request from an account holder. Responsive thereto, at 322, the account holder-facing application obtains a token for use in a MO/TO transaction request to be provided to a merchant having access to a merchant-facing application corresponding to said account holder-facing application.

FIG. 4 illustrates an example computing system 400 which could be used to perform either or both of methods 310 and 320. A processor 410, which could comprise multiple processors, possibly in different locations, in communication with one another, is connected to a memory 420, which could comprise multiple memories, possibly in different locations, in communication with one another. Memory 420 stores computer-executable instructions which, when executed by processor 410, cause it to perform one or both of methods 310 and 320.

Other embodiments will be apparent to those skilled in the art from consideration of the specification and practice of the embodiments disclosed herein. It is intended that the specification and examples be considered as exemplary only.

In addition, where this application has listed the steps of a method or procedure in a specific order, it could be possible, or even expedient in certain circumstances, to change the order in which some steps are performed, and it is intended that the particular steps of the method or procedure claims set forth herein not be construed as being order-specific unless such order specificity is expressly stated in the claim. That is, the operations/steps may be performed in any order, unless otherwise specified, and embodiments may include additional or fewer operations/steps than those disclosed herein. It is further contemplated that executing or performing a particular operation/step before, contemporaneously with, or after another operation is in accordance with the described embodiments.

The methods described herein may be encoded as executable instructions embodied in a generator readable medium, including, without limitation, non-transitory generator-readable storage, a storage device, and/or a memory device. Such instructions, when executed by a processor (or one or more generators, processors, and/or other devices) cause the processor (the one or more generators, processors, and/or other devices) to perform at least a portion of the methods described herein. A non-transitory generator-readable storage medium includes, but is not limited to, volatile memory, non-volatile memory, magnetic and optical storage devices such as disk drives, magnetic tape, compact discs (CDs), digital versatile discs (DVDs), or other media that are capable of storing code and/or data.

The methods and processes can also be partially or fully embodied in hardware modules or apparatuses or firmware, so that when the hardware modules or apparatuses are activated, they perform the associated methods and processes. The methods and processes can be embodied using a combination of code, data, and hardware modules or apparatuses.

Examples of processing systems, environments, and/or configurations that may be suitable for use with the embodiments described herein include, but are not limited to, embedded generator devices, personal generators, server generators (specific or cloud (virtual) servers), hand-held or laptop devices, multiprocessor systems, microprocessor-based systems, set top boxes, programmable consumer electronics, mobile telephones, network PCs, minigenerators, mainframe generators, distributed generating environments that include any of the above systems or devices, and the like. Hardware modules or apparatuses described in this disclosure include, but are not limited to, application-specific integrated circuits (ASICs), field-programmable gate arrays (FPGAs), dedicated or shared processors, and/or other hardware modules or apparatuses.

With that said, it should be appreciated that one or more aspects of the present disclosure transform a general-purpose computing device into a special-purpose computing device when configured to perform the functions, methods, and/or processes described herein.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of processing a Mail Order/Telephone Order (MO/TO) transaction, said method being performed by a MO/TO merchant-facing application running on a processor of a merchant computing device and comprising:
receiving, by the computing device, a MO/TO transaction request, comprising data corresponding to a token, from a merchant; and
responsive thereto, initiating, by the computing device, obtaining payment credentials using said data.

2. The method of claim 1, further comprising:
initiating, by the computing device, validation of said credentials to authorise and complete said transaction;
subsequent to said authorisation, receiving, by the computing device, a transaction approval; and
responsive thereto, providing said merchant with a transaction confirmation.

3. The method of claim 1, wherein said obtaining comprises matching the data corresponding to the token to data corresponding to the credentials stored by said payment application or an entity in communication with it.

4. The method of claim 3, wherein said matching comprises searching for the data corresponding to the token, or a code derived therefrom, according to a predetermined algorithm, in a look-up table comprising pairs of linked token data and credential data.

5. The method of claim 1, wherein said obtaining comprises operating on the data corresponding to the token according to a predetermined decoding algorithm to output data corresponding to the credentials.

6. The method of claim 5, wherein said transaction request further comprises a timestamp and both the data corresponding to the token and said timestamp are input to said decoding algorithm.

7. The method of claim 1, wherein said obtaining comprises checking that the token is not present on a list of previously used tokens.

8. (canceled)

9. A method of securing a Mail Order/Telephone Order (MO/TO) transaction, said method being performed by a MO/TO account holder-facing application running on a processor of an account holder computing device and comprising:
receiving, by the computing device, a MO/TO token request from an account holder; and
responsive thereto, obtaining, by the computing device, data corresponding to a token for use in a MO/TO transaction request to be provided to a merchant having access to a merchant-facing application corresponding to said account holder-facing application, said merchant-facing application being configured to initiate obtaining payment credentials using said data corresponding to the token.

10. The method of claim 9, further comprising, prior to said obtaining, verifying said account holder's identity.

11. The method of claim 9, wherein said obtaining comprises operating on data corresponding to a stored account identifier for an account held by said account holder according to a predetermined algorithm.

12. The method of claim 11, wherein said operating further comprises inputting data corresponding to a current time value to said algorithm.

13. The method of claim 9, wherein said merchant-facing application is configured to subsequently:
receive, by a merchant computing device upon which the merchant-facing application is running, a MO/TO transaction request, comprising data corresponding to a token, from the merchant; and
responsive thereto, initiate, by the merchant computing device, obtaining payment credentials using said data.

14. (canceled)

15. (canceled)

16. A system for processing a Mail Order/Telephone Order (MO/TO) transaction, the system comprising:
an account holder computing device configured to:
receive a MO/TO token request from an account holder; and
responsive thereto, obtain data corresponding to a token for use in a MO/TO transaction request; and
a merchant computing device configured to:
receive the MO/TO transaction request, comprising the data corresponding to the token; and
responsive thereto, initiate obtaining payment credentials using said data.
